(19) United States
(12) Patent Application Publication
(10) Pub. No.: US 2026/0238887 A1
(43) Pub. Date: Aug. 13, 2026

(54) CONTROL METHOD AND APPARATUS FOR EYE TRACKING APPARATUS, ELECTRONIC DEVICE, AND STORAGE MEDIUM

(71) Applicant: VIVO MOBILE COMMUNICATION CO., LTD., Dongguan (CN)

(72) Inventor: Mu LIU, Dongguan (CN)

(73) Assignee: VIVO MOBILE COMMUNICATION CO., LTD., Dongguan (CN)

(21) Appl. No.: 19/566,918

(22) Filed: Mar. 13, 2026

Related U.S. Application Data
(63) Continuation of application No. PCT/CN2024/118390, filed on Sep. 12, 2024.

(30) Foreign Application Priority Data
Sep. 18, 2023 (CN) 202311202153.X

(51) Int. Cl. H04N 23/74; G06T 7/62; G06T 7/73; H04N 23/56; G06F 3/01

(52) U.S. Cl. CPC H04N 23/74; G06T 7/62; G06T 7/74; H04N 23/56; G06F 3/013; G06T 2207/30201

(57) ABSTRACT

An eye tracking apparatus includes a tracking module and at least one light emitting member, the at least one light emitting member is configured to emit light to an eyeball, the tracking module is configured to: generate a first image of the eyeball, and track the eyeball based on a light spot on the eyeball in the first image. A control method for the eye tracking apparatus includes: obtaining an on/off state of the at least one light emitting member; obtaining a light spot status corresponding to the at least one light emitting member in the first image; and controlling, based on the on/off state and the light spot status, the at least one light emitting member to be turned on or turned off.

### CROSS-REFERENCE TO RELATED APPLICATIONS

This application is a continuation of International Application No. PCT/CN2024/118390, filed September 12, 2024, which claims priority to Chinese Patent Application No. 202311202153.X, filed September 18, 2023. The entire contents of each of the above-referenced applications are expressly incorporated herein by reference.

### TECHNICAL FIELD

This application pertains to the field of virtual reality device technologies, and specifically relates to a control method and apparatus for an eye tracking apparatus, an electronic device, and a storage medium.

### BACKGROUND

In a related technology, a head-mounted virtual reality device is equipped with an eye tracking apparatus, and the eye tracking apparatus is configured to track eyeball rotation of a user when the user wears the virtual reality device, to ensure a viewing effect of the user. The eye tracking apparatus emits light to the eyeball of the user by using a plurality of infrared lamps. The eye tracking apparatus can generate an image of the eyeball by using a tracking module. A light spot formed by the infrared lamp on the eyeball can be displayed on the image of the eyeball. Then the tracking module determines a rotation direction of the eyeball based on a relative location between the light spot and the eyeball.

In an actual use process, to ensure that more light spots can be obtained, that is, to ensure accuracy of eyeball rotation direction tracking, the eye tracking apparatus needs to turn on all infrared lamps. Consequently, the virtual reality device has relatively large power consumption, resulting in heating of the virtual reality device, and affecting usage experience of the virtual reality device.

### SUMMARY

Embodiments of this application are intended to provide a control method and apparatus for an eye tracking apparatus, an electronic device, and a readable storage medium.

According to a first aspect, an embodiment of this application provides a control method for an eye tracking apparatus. The eye tracking apparatus includes a tracking module and at least one light emitting member, the at least one light emitting member is configured to emit light to an eyeball, the tracking module is configured to: generate a first image of the eyeball, and track the eyeball based on a light spot on the eyeball in the first image, and the control method includes:

obtaining an on/off state of the light emitting member;

obtaining a light spot status corresponding to the light emitting member from the first image; and

controlling, based on the on/off state and the light spot status, the light emitting member to be turned on or turned off.

According to a second aspect, an embodiment of this application provides a control apparatus for an eye tracking apparatus. The eye tracking apparatus includes a tracking module and at least one light emitting member, the at least one light emitting member is configured to emit light to an eyeball to form a light spot on the eyeball, the tracking module is configured to: generate a first image of the eyeball, and track the eyeball based on the light spot in the first image, and the control apparatus includes:

an obtaining unit, configured to: obtain an on/off state of the light emitting member; and

obtain a light spot status corresponding to the light emitting member from the first image; and

a control unit, configured to control, based on the on/off state and the light spot status, the light emitting member to be turned on or turned off.

According to a third aspect, an embodiment of this application provides an electronic device, including a processor and a memory. The memory stores a program or instructions capable of running on the processor, and the steps of the method according to the first aspect are implemented when the program or the instructions are executed by the processor.

According to a fourth aspect, an embodiment of this application provides a readable storage medium. The readable storage medium stores a program or instructions, and the steps of the method according to the first aspect are implemented when the program or the instructions are executed by a processor.

According to a fifth aspect, an embodiment of this application provides a chip. The chip includes a processor and a communication interface, the communication interface is coupled to the processor, and the processor is configured to run a program or instructions to implement the steps of the method according to the first aspect.

According to a sixth aspect, an embodiment of this application provides a computer program product. The program product is stored in a readable storage medium, and the program product is executed by at least one processor to implement the method according to the first aspect.

According to a seventh aspect, an embodiment of this application provides a control apparatus for an eye tracking apparatus. The control apparatus for an eye tracking apparatus is configured to perform the method according to the first aspect.

In the embodiments of this application, the eye tracking apparatus includes the at least one light emitting member, and the at least one light emitting member may emit light to an eyeball of a user when the user wears a virtual reality device, to form a light spot on the eyeball of the user. Further, the eye tracking apparatus further includes the tracking module, and the tracking module is configured to generate a first image of the eyeball, to track rotation of the eyeball based on a location of the light spot in the first image.

Further, after the user wears the virtual reality device, an operation state (e.g., on/off state) of the at least one light emitting member is first obtained, that is, whether each light emitting member is in an on state or an off state is obtained. Then a light spot status corresponding to the light emitting member is obtained from the first image. That is, it is determined, from the first image, whether a light spot corresponding to the light emitting member can be obtained from the first image when the light emitting member is turned on.

Further, the light emitting member is controlled, based on a light emitting status of the light emitting member and the light spot status corresponding to the light emitting member, to be turned on or turned off.

It may be understood that in an actual use process, as the eyeball of the user rotates, the tracking module of the eye tracking apparatus obtains a first image at intervals of a period of time, and statuses of the light spot in first images may be different. Therefore, in an eye tracking process, it cannot be ensured that effective light spots can be generated in the first image for all light emitting members. In addition, accuracy of eyeball rotation tracking can be ensured provided that two light spots can be obtained in the first image, instead of obtaining light spots of all the light emitting members. Therefore, the light emitting member is controlled, by using the light emitting status of the light emitting member and the status of the light spot in the first image in the actual use process, to be turned on or turned off, to dynamically control turning on/turning off of the light emitting member in the use process with rotation of the eyeball of the user. In this way, an unnecessary light emitting member is turned off while it is ensured that at least two light spots exist in the first image, that is, a final eyeball effect is ensured, to reduce power consumption of the virtual reality device.

In the embodiments of this application, in the actual use process of the virtual reality device, the on/off state of the light emitting member of the eye tracking apparatus and a status of a light spot in a corresponding first image are obtained, to implement dynamic control on turning on/turning off of the light emitting member with rotation of the eyeball of the user. In this way, an unnecessary light emitting member is turned off while it is ensured that an eye tracking effect is ensured, to reduce power consumption of the virtual reality device and reduce heating of the virtual reality device, thereby improving user experience of the virtual reality device.

### BRIEF DESCRIPTION OF DRAWINGS

FIG. 1 is a flowchart of a control method for an eye tracking apparatus according to an embodiment of this application;

FIG. 2 is a schematic diagram 1 of a first image according to an embodiment of this application;

FIG. 3 is a schematic diagram 2 of a first image according to an embodiment of this application;

FIG. 4 is a schematic diagram of an eyeball region image in the first image in FIG. 3;

FIG. 5 is a schematic diagram of a light spot in the first image in FIG. 3;

FIG. 6 is a schematic diagram 3 of a first image according to an embodiment of this application;

FIG. 7 is a schematic diagram of a light emitting member in an eye tracking apparatus according to an embodiment of this application;

FIG. 8 is a structural block diagram of a control apparatus for an eye tracking apparatus according to an embodiment of this application;

FIG. 9 is a structural block diagram of an electronic device according to an embodiment of this application; and

FIG. 10 is a schematic diagram of a hardware structure of an electronic device for implementing an embodiment of this application.

### DETAILED DESCRIPTION

The following describes technical solutions in embodiments of this application with reference to accompanying drawings in the embodiments of this application. The described embodiments are merely some rather than all of the embodiments of this application. All other embodiments obtained by a person of ordinary skill in the art based on the embodiments of this application shall fall within the protection scope of this application.

It should be noted that the terms "first", "second", and the like in the specification and claims of this application are intended to distinguish between similar objects but do not necessarily indicate a specific order or sequence. It should be understood that data used in this way is interchangeable under appropriate circumstances, so that the embodiments of this application can be implemented in an order other than that illustrated or described herein. Moreover, the terms such as "first", "second", and the like typically distinguish between objects of one category rather than limiting a quantity of objects. For example, there may be one or more first objects. In addition, in the specification and claims, "and/or" represents at least one of the connected objects, and the character "/" usually represents an "or" relationship between associated objects.

With reference to the accompanying drawings, a control method and apparatus for an eye tracking apparatus, an electronic device, and a readable storage medium that are provided in the embodiments of this application are described in detail below by using specific embodiments and application scenarios thereof.

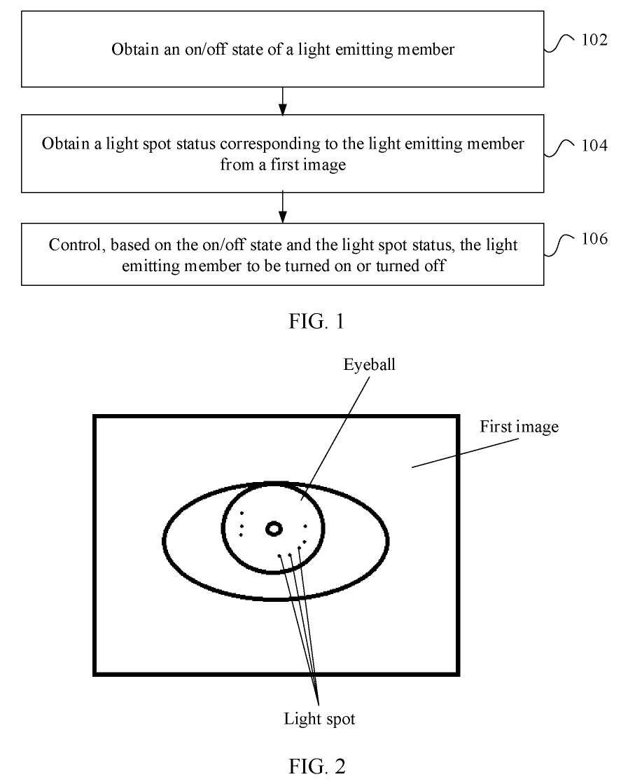

In some embodiments of this application, a control method for an eye tracking apparatus is provided. The eye tracking apparatus includes a tracking module and at least one light emitting member, the at least one light emitting member is configured to emit light to an eyeball, and the tracking module is configured to: generate a first image of the eyeball, and track the eyeball based on a light spot on the eyeball in the first image. FIG. 1 is a flowchart of a control method for an eye tracking apparatus according to an embodiment of this application. As shown in FIG. 1, the control method for an eye tracking apparatus includes the following steps:

Step 102: Obtain an on/off state of a light emitting member.

Step 104: Obtain a light spot status corresponding to the light emitting member from a first image.

Step 106: Control, based on the on/off state and the light spot status, the light emitting member to be turned on or turned off.

In this embodiment of this application, the control method for an eye tracking apparatus is performed by an electronic device, and the electronic device may be a virtual reality device (a VR device or an AR device), a mobile phone, a tablet computer, a notebook computer, or the like.

In some feasible implementations, the eye tracking apparatus includes at least one light emitting member, and the at least one light emitting member may emit light to an eyeball of a user when the user wears the virtual reality device. Further, the eye tracking apparatus further includes a tracking module, and the tracking module is configured to generate a first image of the eyeball. In the first image, a light spot formed by the light emitting member on the eyeball can be displayed, so that rotation of the eyeball is tracked based on a location of the light spot in the first image.

Further, after the user wears the virtual reality device, an on/off state of the at least one light emitting member is first obtained, that is, whether each light emitting member is in an on state or an off state is obtained. Then a light spot status corresponding to the light emitting member is obtained from the first image. That is, it is determined, from the first image, whether a light spot corresponding to the light emitting member can be obtained from the first image when the light emitting member is turned on.

Further, the light emitting member is controlled, based on a light emitting status of the light emitting member and the light spot status corresponding to the light emitting member, to be turned on or turned off.

FIG. 2 is a schematic diagram 1 of a first image according to an embodiment of this application. As shown in FIG. 2, in an actual use process, as the eyeball of the user rotates, the tracking module of the eye tracking apparatus obtains a first image at intervals of a period of time, and statuses of the light spot in first images may be different. Therefore, in an eye tracking process, it cannot be ensured that effective light spots can be generated in the first image for all light emitting members. In addition, accuracy of eyeball rotation tracking can be ensured provided that two light spots can be obtained in the first image, instead of obtaining light spots of all the light emitting members. Therefore, the light emitting member is controlled, by using the light emitting status of the light emitting member and the status of the light spot in the first image in the actual use process, to be turned on or turned off, to dynamically control turning on/turning off of the light emitting member in the use process with rotation of the eyeball of the user. In this way, an unnecessary light emitting member is turned off while it is ensured that at least two light spots exist in the first image, that is, a final eyeball effect is ensured, to reduce power consumption of the virtual reality device.

In this embodiment of this application, in the actual use process of the virtual reality device, the on/off state of the light emitting member of the eye tracking apparatus and a status of a light spot in a corresponding first image are obtained, to implement dynamic control on turning on/turning off of the light emitting member with rotation of the eyeball of the user. In this way, an unnecessary light emitting member is turned off while it is ensured that an eye tracking effect is ensured, to reduce power consumption of the virtual reality device and reduce heating of the virtual reality device, thereby improving user experience of the virtual reality device.

In some embodiments of this application, the controlling, based on the on/off state and the light spot status, the light emitting member to be turned on or turned off includes:

in a case that the light emitting member is in an on state, and the light spot status corresponding to the light emitting member is absent in N frames of consecutively generated first images, controlling the light emitting member to be turned off, where N is a positive integer.

In this embodiment of this application, in a case that the light emitting member is in the on state, the N frames of consecutively generated first images are obtained, and then the light spot status corresponding to the light emitting member in the on state is detected in the N frames of consecutively generated first images. If the light spot status corresponding to the light emitting member is absent in the N frames of consecutively generated first images, that is, the light emitting member is in the on state, but no light spot corresponding to the light emitting member is detected in the first image, it indicates that the light emitting member in the on state does not form an effective light spot in the first image, and in this case, the light emitting member may be turned off, so that power consumption of the virtual reality device is prevented from increasing because the light emitting member keeps on for a long time.

In some feasible implementations, in an actual running process, a table may be established for collecting statistics on all the light emitting members and whether light spots corresponding to the light emitting members exist, and statistics on an on/off state of each light emitting member and corresponding light spot statuses in the N frames of consecutively generated first images are collected by using the table. For example, if a light emitting member is in the on state, +1 is recorded for the light emitting member in the table, and if a light emitting member is in the off state, statistics on a status of the light emitting member are collected as –1. In a case that a light spot corresponding to a light emitting member exists, statistics on a light spot status are collected as 0, and in a case that no light spot exists, statistics on a light spot status are collected as null. It is determined, based on statistical data in the table, whether no light spot corresponding to a light emitting member is detected in N frames of consecutively generated first images when the light emitting member is in the on state, so that the light emitting member is controlled.

In this embodiment of this application, a light spot status corresponding to a light emitting member that is turned on is determined in the N frames of consecutively generated first images, and in a case that the light spot status is absent in the N frames of consecutively generated first images, it may be determined that the light emitting member is turned on but does not effectively form a light spot in the first image, and in this case, the light emitting member is turned off, to reduce power consumption of the virtual reality device.

In some embodiments of this application, the light spot status further includes a quantity of pixels of the light spot, and the controlling, based on the on/off state and the light spot status, the light emitting member to be turned on or turned off includes:

in a case that the light emitting member is in an on state, and the quantity of pixels of the light spot corresponding to the light emitting member is greater than a first value, controlling the light emitting member corresponding to the light spot to be turned off; and

in a case that the light emitting member is in the on state, and the quantity of pixels of the light spot corresponding to the light emitting member is less than a second value, controlling the light emitting member corresponding to the light spot to be turned off.

In this embodiment of this application, if the quantity of pixels of the light spot detected in the first image is greater than the first value or the quantity of pixels of the light spot is less than the second value, it indicates that the light spot is abnormal, which may affect an eye tracking effect. In this case, the light emitting member corresponding to the light spot may be turned off, to ensure the eye tracking effect.

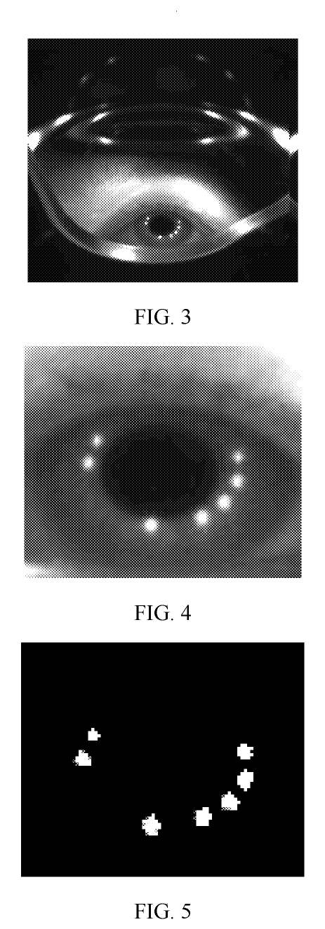

It may be understood that FIG. 3 is a schematic diagram 2 of a first image according to an embodiment of this application, FIG. 4 is a schematic diagram of an eyeball region image in the first image in FIGS. 3 and 5, is a schematic diagram of a light spot in the first image in FIG. 3. As shown in FIGS. 3, 4 and 5, the quantity of pixels of the light spot in the first image may be determined by analyzing the first image. In some feasible implementations, the first image may be first analyzed by using an image analysis algorithm such as a Histogram of Gradient algorithm or a Harr-like algorithm, to extract the eyeball region image from the first image. Further, the eyeball region image is processed, light spot information in the eyeball region image is extracted, and the quantity of pixels of the light spot is obtained, to determine, based on the quantity of the pixels of the light spot, whether to turn on or turn off the light emitting member corresponding to the light spot.

In this embodiment of this application, the quantity of pixels of the light spot in the first image is determined, to determine whether display of the light spot in the first image is abnormal. In a case that the quantity of pixels of the light spot is greater than the first value or is less than the second value, it may be determined that display of the light spot is abnormal. In this case, the light emitting member corresponding to the light spot is turned off, to ensure an eye tracking effect and reduce power consumption.

In some embodiments of this application, the light spot status further includes a ratio of a length of the light spot to a width of the light spot, and the controlling, based on the on/off state and the light spot status, the light emitting member to be turned on or turned off includes:

in a case that the light emitting member is in an on state, and the ratio of the length of the light spot corresponding to the light emitting member to the width of the light spot is greater than a third value, controlling the light emitting member to be turned off.

In this embodiment of this application, in a case that it is detected in the first image that the ratio of the length to the width of the light spot is greater than the third value, it indicates that the light spot is abnormal, which may affect an eye tracking effect. In this case, the light emitting member corresponding to the light spot may be turned off, to ensure the eye tracking effect. It may be understood that the length of the light spot may be a maximum size of the light spot in a first direction, the width of the light spot may be a maximum size of the light spot in a second direction, and the first direction and the second direction are not parallel.

It may be understood that FIG. 3 is a schematic diagram 2 of a first image according to an embodiment of this application, FIG. 4 is a schematic diagram of an eyeball region image in the first image in FIGS. 3 and 5 is a schematic diagram of a light spot in the first image in FIG. 3. As shown in FIGS. 3, 4 and 5 the quantity of pixels of the light spot in the first image may be determined by analyzing the first image. In some feasible implementations, the first image may be first analyzed by using an image analysis algorithm such as a Histogram of Gradient algorithm or a Harr-like algorithm, to extract the eyeball region image from the first image. Further, the eyeball region image is processed, light spot information in the eyeball region image is extracted, the length and the width of the light spot are obtained, then the ratio of the length to the width of the light spot is determined, and then it is determined whether to turn on or turn off the light emitting member corresponding to the light spot.

In this embodiment of this application, the ratio of the length to the width of the light spot is obtained, to determine whether display of the light spot in the first image is abnormal. In the case that the ratio of the length to the width of the light spot is greater than the third value, it may be determined that display of the light spot is abnormal. In this case, the light emitting member corresponding to the light spot is turned off, to ensure an eye tracking effect and reduce power consumption.

In some embodiments of this application, the controlling, based on the on/off state and the light spot status, the light emitting member to be turned on or turned off further includes:

in a case that duration for which the light emitting member remains in an off state reaches first duration, controlling the light emitting member to be turned on.

In some embodiments of this application, a turn-on occasion of the light emitting member may be determined based on the duration for which the light emitting member remains in the off state. That is, in the case that the duration for which the light emitting member remains in the off state reaches the first duration, the light emitting member may be controlled to be turned on. In some feasible implementations, the first duration may be set to 33 milliseconds.

In this embodiment of this application, when the duration for which the light emitting member remains in the off state reaches the first duration, the light emitting member is turned on, so that the quantity of light spots in the first image can be prevented from failing to meet an eye tracking requirement, and an eye tracking effect is ensured.

In some embodiments of this application, the controlling, based on the on/off state and the light spot status, the light emitting member to be turned on or turned off further includes:

in a case that a quantity of light spots in the first image is less than a fourth value, controlling all light emitting members to be turned on.

In some embodiments of this application, a turn-on occasion of the light emitting member may be determined based on the quantity of light spots in the first image. That is, in a case that the quantity of light spots in the first image is less than the fourth value, all the light emitting members are turned on.

It may be understood that to ensure that the light spot can meet the eye tracking requirement, it needs to be ensured that the quantity of light spots in the first image is greater than or equal to 2. Therefore, in a case that the quantity of light spots in the first image is less than 2, all the light emitting members are turned on, to ensure that the quantity of light spots in the first image is greater than or equal to 2, thereby ensuring an eye tracking effect. That is, the fourth value may be 2.

In this embodiment of this application, the quantity of light spots in the first image is determined, so that when the quantity of light spots in the first image is less than the fourth value, all the light emitting members are turned on, to ensure that the quantity of light spots in the first image is greater than or equal to the fourth value, thereby ensuring eye tracking accuracy.

In some embodiments of this application, before the obtaining an on/off state of the light emitting member, the control method further includes:

obtaining distribution statuses of light spots in M frames of first images, where M is an integer greater than or equal to 2; and

determining a correspondence between the light emitting member and the light spot based on on/off states of the light emitting member that correspond to the M frames of first images and the distribution statuses of the light spots in the M frames of first images.

In this embodiment of this application, before the light emitting member is controlled, by using the on/off state of the light emitting member and the status of the light spot in the first image, to be turned on or turned off, the correspondence between the light emitting member and the light spot first needs to be determined, to ensure accuracy in a process of controlling the light emitting member to be turned on or turned off, thereby avoiding a calculation error in an eye tracking process.

In some feasible implementations, the distribution statuses of the light spots in the M frames of first images are first obtained, where M is an integer greater than or equal to 2. That is, at least two first images are obtained. Then the correspondence between the light emitting member and the light spot is determined based on an on/off state that is of a light emitting member and that corresponds to each frame of first image and a distribution status of the light spots in each frame of first image. The on/off states of the light emitting member that correspond to all the frames of first images are different. That is, the distribution statuses of the light spots in the M frames of first images are compared, and a light spot corresponding to each light emitting member is determined with reference to an on/off state that is of the light emitting member and that corresponds to each first image.

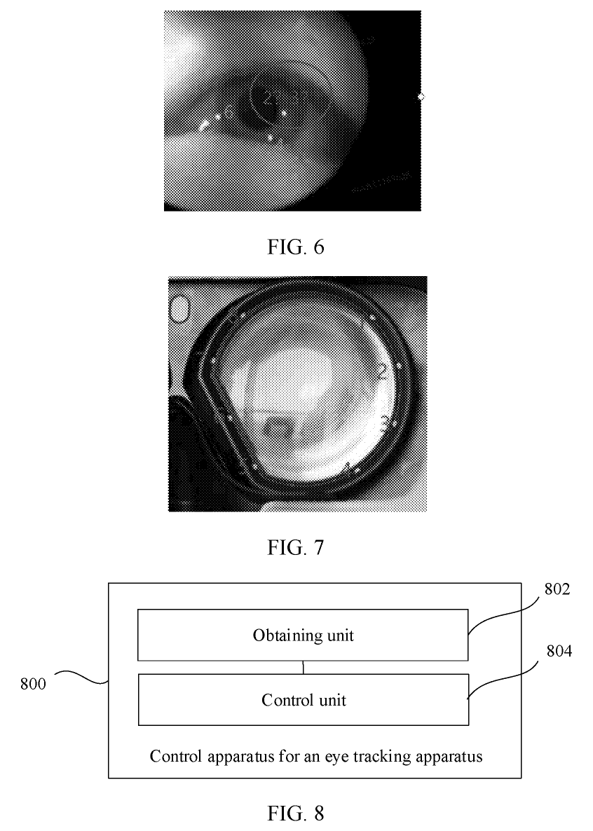

For example, FIG. 6 is a schematic diagram 3 of a first image according to an embodiment of this application, and FIG. 7 is a schematic diagram of a light emitting member in an eye tracking apparatus according to an embodiment of this application, as shown in FIG. 6 and FIG. 7. There are eight light emitting members. In a first image at a first moment, a light spot appears, and it is difficult to determine whether a light spot on the rightmost side of a pupil corresponds to a light emitting member 2 or 3. In this case, at a second moment, the light emitting member 2 may be controlled to be turned off. Then a first image at the second moment is viewed. If the light spot on the rightmost side of the pupil disappears in the first image at the second moment, it may be determined that a sequence number of a lamp corresponding to the light spot is 2. On the contrary, if the light spot in the first image at the second moment still exists, it may be determined that a sequence number of a lamp corresponding to the light spot is 3. Generally, one light spot corresponds to a maximum of three undetermined light emitting members. A correct relationship between the light spot and a light emitting member may be determined by sequentially controlling two of the light emitting members to be turned on or turned off. It is assumed that in a first image at a first moment, suspected light emitting members corresponding to a light spot are numbered 1, 2, and 3. In the first step, at a second moment, the light emitting member 1 is controlled to be turned off, and the light spot disappears in a first image at the second moment. It may be determined that the light emitting member 1 corresponds to the light spot. Otherwise, the light emitting member 1 is ruled out, and the next step is performed. At a third moment, the light emitting member 2 is controlled to be turned off, and the light spot disappears in a first image at the third moment. It may be determined that the light emitting member 2 corresponds to the light spot. Otherwise, it is determined that the light emitting member 3 corresponds to the light spot. The process ends and is exited.

In this embodiment of this application, the distribution statuses of the light spots in the M frames of first images and the on/off states of the light emitting member in the M frames of first images are obtained, so that the correspondence between the light emitting member and the light spot is determined based on the distribution statuses of the light spots in the M frames of first images and the corresponding on/off states of the light emitting member, thereby avoiding affecting a process of an eye tracking algorithm because of inaccuracy in determining a light spot location, that is, ensuring robustness of the eye tracking algorithm.

In some embodiments of this application, before the obtaining an on/off state of the light emitting member, the control method further includes:

at a first moment, separately obtaining a distribution status of light spots in a first image corresponding to a left eyeball and a distribution status of the light spots in a first image corresponding to a right eyeball; and

determining a correspondence between the light emitting member and the light spot based on the distribution status of the light spots in the first image corresponding to the left eyeball and the distribution status of the light spots in the first image corresponding to the right eyeball.

In some embodiments of this application, the correspondence between the light emitting member and the light spot may be determined by using the distribution statuses of the light spots in the first image corresponding to the left eyeball and the first image corresponding to the right eyeball at the first moment. That is, the correspondence between the light emitting member and the light spot is determined by using symmetry of human left and right eyes.

In some feasible implementations, the first images corresponding to the left eyeball and the right eyeball are separately obtained, then the distribution statuses of the light spots in the two first images are compared, that is, a relative location between each light spot and the eyeball is determined, and then the correspondence between the light emitting member and the light spot is determined by using a symmetrical relationship between the left eyeball and the right eyeball and with reference to the on/off state of the light emitting member.

In this embodiment of this application, the correspondence between the light emitting member and the light spot is determined based on the distribution statuses of the light spots in the first image of the left eyeball and the first image of the right eyeball at the first moment by using symmetry of the left eyeball and the right eyeball, thereby avoiding affecting a process of an eye tracking algorithm because of inaccuracy in determining a light spot location, that is, ensuring robustness of the eye tracking algorithm.

In some embodiments of this application, a control apparatus for an eye tracking apparatus is provided. The eye tracking apparatus includes a tracking module and at least one light emitting member, the at least one light emitting member is configured to emit light to an eyeball, and the tracking module is configured to: generate a first image of the eyeball, and track the eyeball based on a light spot on the eyeball in the first image. FIG. 8 is a structural block diagram of a control apparatus 800 for an eye tracking apparatus according to an embodiment of this application. As shown in FIG. 8, the control apparatus 800 for an eye tracking apparatus includes:

an obtaining unit 802, configured to: obtain an on/off state of the light emitting member; and

obtain a light spot status corresponding to the light emitting member from the first image; and

a control unit 804, configured to control, based on the on/off state and the light spot status, the light emitting member to be turned on or turned off.

In this embodiment of this application, in an actual use process of a virtual reality device, the on/off state of the light emitting member of the eye tracking apparatus and a status of a light spot in a corresponding first image are obtained, to implement dynamic control on turning on/turning off of the light emitting member with rotation of an eyeball of a user. In this way, an unnecessary light emitting member is turned off while it is ensured that an eye tracking effect is ensured, to reduce power consumption of the virtual reality device and reduce heating of the virtual reality device, thereby improving user experience of the virtual reality device.

In some embodiments of this application, the control unit is configured to: in a case that the light emitting member is in an on state, and the light spot status corresponding to the light emitting member is absent in N frames of consecutively generated first images, control the light emitting member to be turned off, where N is a positive integer.

In this embodiment of this application, a light spot status corresponding to a light emitting member that is turned on is determined in the N frames of consecutively generated first images, and in a case that the light spot status is absent in the N frames of consecutively generated first images, it may be determined that the light emitting member is turned on but does not effectively form a light spot in the first image, and in this case, the light emitting member is turned off, to reduce power consumption of the virtual reality device.

In some embodiments of this application, the light spot status further includes a quantity of pixels of the light spot; and the control unit is configured to: in a case that the light emitting member is in an on state, and the quantity of pixels of the light spot corresponding to the light emitting member is greater than a first value, control the light emitting member corresponding to the light spot to be turned off; and

in a case that the light emitting member is in the on state, and the quantity of pixels of the light spot corresponding to the light emitting member is less than a second value, control the light emitting member corresponding to the light spot to be turned off.

In this embodiment of this application, the quantity of pixels of the light spot in the first image is determined, to determine whether display of the light spot in the first image is abnormal. In a case that the quantity of pixels of the light spot is greater than the first value or is less than the second value, it may be determined that display of the light spot is abnormal. In this case, the light emitting member corresponding to the light spot is turned off, to ensure an eye tracking effect and reduce power consumption.

In some embodiments of this application, the light spot status further includes a ratio of a length of the light spot to a width of the light spot; and the control unit is configured to: in a case that the light emitting member is in an on state, and the ratio of the length of the light spot corresponding to the light emitting member to the width of the light spot is greater than a third value, control the light emitting member to be turned off.

In this embodiment of this application, the ratio of the length to the width of the light spot is obtained, to determine whether display of the light spot in the first image is abnormal. In the case that the ratio of the length to the width of the light spot is greater than the third value, it may be determined that display of the light spot is abnormal. In this case, the light emitting member corresponding to the light spot is turned off, to ensure an eye tracking effect and reduce power consumption.

In some embodiments of this application, the control unit is further configured to: in a case that duration for which the light emitting member remains in an off state reaches first duration, control the light emitting member to be turned on.

In this embodiment of this application, when the duration for which the light emitting member remains in the off state reaches the first duration, the light emitting member is turned on, so that the quantity of light spots in the first image can be prevented from failing to meet an eye tracking requirement, and an eye tracking effect is ensured.

In some embodiments of this application, the control unit is further configured to: in a case that a quantity of light spots in the first image is less than a fourth value, control all light emitting members to be turned on.

In this embodiment of this application, the quantity of light spots in the first image is determined, so that when the quantity of light spots in the first image is less than the fourth value, all the light emitting members are turned on, to ensure that the quantity of light spots in the first image is greater than or equal to the fourth value, thereby ensuring eye tracking accuracy.

In some embodiments of this application, the obtaining unit is further configured to obtain distribution statuses of light spots in M frames of first images, where M is an integer greater than or equal to 2; and

the control apparatus further includes a determining unit, configured to determine a correspondence between the light emitting member and the light spot based on on/off states of the light emitting member that correspond to the M frames of first images and the distribution statuses of the light spots in the M frames of first images, where the on/off states of the light emitting member that correspond to the M frames of first images are different.

In this embodiment of this application, the distribution statuses of the light spots in the M frames of first images and the on/off states of the light emitting member in the M frames of first images are obtained, so that the correspondence between the light emitting member and the light spot is determined based on the distribution statuses of the light spots in the M frames of first images and the corresponding on/off states of the light emitting member, thereby avoiding affecting a process of an eye tracking algorithm because of inaccuracy in determining a light spot location, that is, ensuring robustness of the eye tracking algorithm.

In some embodiments of this application, the obtaining unit is further configured to: at a first moment, separately obtain a distribution status of light spots in a first image corresponding to a left eyeball and a distribution status of the light spots in a first image corresponding to a right eyeball; and

the determining unit is further configured to determine a correspondence between the light emitting member and the light spot based on the distribution status of the light spots in the first image corresponding to the left eyeball and the distribution status of the light spots in the first image corresponding to the right eyeball.

The control apparatus for an eye tracking apparatus in this embodiment of this application may be an electronic device, or may be a component such as an integrated circuit or a chip in an electronic device. The electronic device may be a terminal, or may be another device other than a terminal. For example, the electronic device may be a mobile phone, a tablet computer, a notebook computer, a palmtop computer, an in-vehicle electronic device, a mobile Internet device (Mobile Internet Device, MID), an augmented reality (augmented reality, AR)/virtual reality (virtual reality, VR) device, a robot, a wearable device, a ultra-mobile personal computer (ultra-mobile personal computer, UMPC), a netbook or a personal digital assistant (personal digital assistant, PDA), or the like, or may be a server, a network attached storage (Network Attached Storage, NAS), a personal computer (personal computer, PC), a television (television, TV), a teller machine, an automated machine, or the like. This is not limited in this embodiment of this application.

The control apparatus for an eye tracking apparatus in this embodiment of this application may be an apparatus with an operating system. The operating system may be an Android (Android) operating system, an iOS operating system, or another possible operating system, and is not limited in this embodiment of this application.

The control apparatus for an eye tracking apparatus provided in this embodiment of this application can implement the processes implemented in the foregoing method embodiments. To avoid repetition, details are not described herein again.

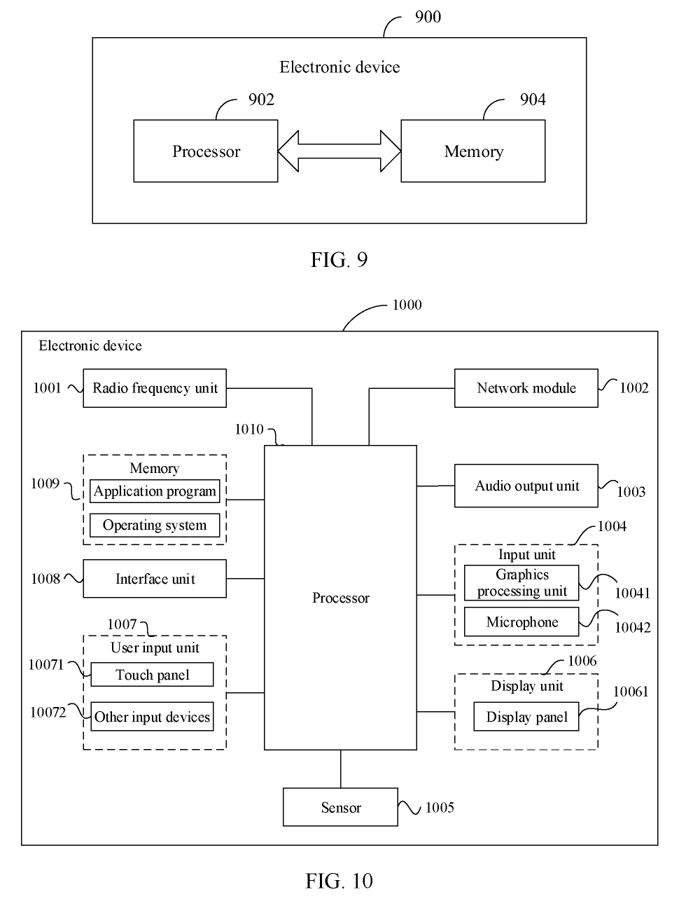

For example, an embodiment of this application further provides an electronic device. FIG. 9 is a structural block diagram of an electronic device according to an embodiment of this application. As shown in FIG. 9, the electronic device 900 includes a processor 902, a memory 904, and a program or instructions that are stored in the memory 904 and that are capable of running on the processor 902. The processes of the foregoing method embodiment are implemented when the program or the instructions are executed by the processor 902, and same technical effects can be achieved. To avoid repetition, details are not described herein again.

It should be noted that the electronic device in this embodiment of this application includes the foregoing mobile electronic device and a non-mobile electronic device.

FIG. 10 is a schematic diagram of a hardware structure of an electronic device for implementing an embodiment of this application.

The electronic device 1000 includes but is not limited to components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the electronic device 1000 may further include a power supply (for example, a battery) that supplies power to each component, and the power supply may be logically connected to the processor 1010 by using a power management system, to implement functions such as charging management, discharging management, and power consumption management by using the power management system. The structure of the electronic device shown in FIG. 10 constitutes no limitation on the electronic device. The electronic device may include more or fewer components than those shown in the figure, or combine some components, or have different component arrangements. Details are not described herein again.

The processor 1010 is configured to: obtain an on/off state of a light emitting member; obtain a light spot status corresponding to the light emitting member from a first image; and control, based on the on/off state and the light spot status, the light emitting member to be turned on or turned off.

In this embodiment of this application, in an actual use process of a virtual reality device, the on/off state of the light emitting member of an eye tracking apparatus and a status of a light spot in a corresponding first image are obtained, to implement dynamic control on turning on/turning off of the light emitting member with rotation of an eyeball of a user. In this way, an unnecessary light emitting member is turned off while it is ensured that an eye tracking effect is ensured, to reduce power consumption of the virtual reality device and reduce heating of the virtual reality device, thereby improving user experience of the virtual reality device.

In some embodiments, the processor 1010 is further configured to: in a case that the light emitting member is in an on state, and the light spot status corresponding to the light emitting member is absent in N frames of consecutively generated first images, control the light emitting member to be turned off, where N is a positive integer.

In this embodiment of this application, a light spot status corresponding to a light emitting member that is turned on is determined in the N frames of consecutively generated first images, and in a case that the light spot status is absent in the N frames of consecutively generated first images, it may be determined that the light emitting member is turned on but does not effectively form a light spot in the first image, and in this case, the light emitting member is turned off, to reduce power consumption of the virtual reality device.

In some embodiments, the light spot status further includes a quantity of pixels of the light spot, and the processor 1010 is further configured to: in a case that the light emitting member is in an on state, and the quantity of pixels of the light spot corresponding to the light emitting member is greater than a first value, control the light emitting member corresponding to the light spot to be turned off; and in a case that the light emitting member is in the on state, and the quantity of pixels of the light spot corresponding to the light emitting member is less than a second value, control the light emitting member corresponding to the light spot to be turned off.

In this embodiment of this application, the quantity of pixels of the light spot in the first image is determined, to determine whether display of the light spot in the first image is abnormal. In a case that the quantity of pixels of the light spot is greater than the first value or is less than the second value, it may be determined that display of the light spot is abnormal. In this case, the light emitting member corresponding to the light spot is turned off, to ensure an eye tracking effect and reduce power consumption.

In some embodiments, the light spot status further includes a ratio of a length of the light spot to a width of the light spot, and the processor 1010 is further configured to: in a case that the light emitting member is in an on state, and the ratio of the length of the light spot corresponding to the light emitting member to the width of the light spot is greater than a third value, control the light emitting member to be turned off.

In this embodiment of this application, the ratio of the length to the width of the light spot is obtained, to determine whether display of the light spot in the first image is abnormal. In the case that the ratio of the length to the width of the light spot is greater than the third value, it may be determined that display of the light spot is abnormal. In this case, the light emitting member corresponding to the light spot is turned off, to ensure an eye tracking effect and reduce power consumption.

In some embodiments, the processor 1010 is further configured to: in a case that duration for which the light emitting member remains in an off state reaches first duration, control the light emitting member to be turned on.

In this embodiment of this application, when the duration for which the light emitting member remains in the off state reaches the first duration, the light emitting member is turned on, so that the quantity of light spots in the first image can be prevented from failing to meet an eye tracking requirement, and an eye tracking effect is ensured.

In some embodiments, the processor 1010 is further configured to: in a case that a quantity of light spots in the first image is less than a fourth value, control all light emitting members to be turned on.

In this embodiment of this application, the quantity of light spots in the first image is determined, so that when the quantity of light spots in the first image is less than the fourth value, all the light emitting members are turned on, to ensure that the quantity of light spots in the first image is greater than or equal to the fourth value, thereby ensuring eye tracking accuracy.

In some embodiments, before obtaining the on/off state of the light emitting member, the processor 1010 is further configured to: obtain distribution statuses of light spots in M frames of first images, where M is an integer greater than or equal to 2; and determine a correspondence between the light emitting member and the light spot based on on/off states of the light emitting member that correspond to the M frames of first images and the distribution statuses of the light spots in the M frames of first images, where the on/off states of the light emitting member that correspond to the M frames of first images are different.

In this embodiment of this application, the distribution statuses of the light spots in the M frames of first images and the on/off states of the light emitting member in the M frames of first images are obtained, so that the correspondence between the light emitting member and the light spot is determined based on the distribution statuses of the light spots in the M frames of first images and the corresponding on/off states of the light emitting member, thereby avoiding affecting a process of an eye tracking algorithm because of inaccuracy in determining a light spot location, that is, ensuring robustness of the eye tracking algorithm.

In some embodiments, before obtaining the on/off state of the light emitting member, the processor 1010 is further configured to: at a first moment, separately obtain a distribution status of light spots in a first image corresponding to an left eyeball and a distribution status of the light spots in a first image corresponding to a right eyeball; and determine a correspondence between the light emitting member and the light spot based on the distribution status of the light spots in the first image corresponding to the left eyeball and the distribution status of the light spots in the first image corresponding to the right eyeball.

In this embodiment of this application, the correspondence between the light emitting member and the light spot is determined based on the distribution statuses of the light spots in the first image of the left eyeball and the first image of the right eyeball at the first moment by using symmetry of the left eyeball and the right eyeball, thereby avoiding affecting a process of an eye tracking algorithm because of inaccuracy in determining a light spot location, that is, ensuring robustness of the eye tracking algorithm.

It should be understood that in this embodiment of this application, the input unit 1004 may include a graphics processing unit (Graphics Processing Unit, GPU) 10041 and a microphone 10042, and the graphics processing unit 10041 processes image data of a still image or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and other input devices 10072. The touch panel 10071 is also referred to as a touchscreen. The touch panel 10071 may include two parts: a touch detection apparatus and a touch controller. The other input devices 10072 may include but are not limited to a physical keyboard, a function key (such as a volume control key or an on/off key), a trackball, a mouse, and a joystick. Details are not described herein.

The memory 1009 may be configured to store a software program and various data. The memory 1009 may mainly include a first storage area for storing a program or instructions and a second storage area for storing data. The first storage area may store an operating system, an application program or instructions required by at least one function (for example, a sound play function or an image play function), and the like. In addition, the memory 1009 can include a volatile memory or a nonvolatile memory, or the memory 1009 can include both a volatile memory and a nonvolatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1009 in this embodiment of this application includes but is not limited to these memories and any other suitable type of memory.

The processor 1010 may include one or more processing units. In some embodiments, the processor 1010 integrates an application processor and a modem processor. The application processor mainly processes operations related to an operating system, a user interface, an application program, and the like. The modem processor, for example, a baseband processor, mainly processes a wireless communication signal. It may be understood that the foregoing modem processor may not be integrated into the processor 1010.

An embodiment of this application further provides a readable storage medium. The readable storage medium stores a program or instructions. The processes of the foregoing method embodiment are implemented when the program or the instructions are executed by a processor, and same technical effects can be achieved. To avoid repetition, details are not described herein again.

The processor is the processor in the electronic device in the foregoing embodiment. The readable storage medium includes a computer-readable storage medium, such as a read-only memory (Read-Only Memory, ROM), a random access memory (Random Access Memory, RAM), a magnetic disk, or an optical disc.

An embodiment of this application further provides a chip. The chip includes a processor and a communication interface. The communication interface is coupled to the processor. The processor is configured to run a program or instructions to implement the processes of the foregoing method embodiment, and same technical effects can be achieved. To avoid repetition, details are not described herein again.

It should be understood that the chip provided in this embodiment of this application may also be referred to as a system-level chip, a system chip, a chip system, a system-on-chip, or the like.

An embodiment of this application provides a computer program product. The program product is stored in a readable storage medium. The program product is executed by at least one processor to implement the processes of the foregoing method embodiment, and same technical effects can be achieved. To avoid repetition, details are not described herein again.

It should be noted that in this specification, the term "include", "comprise", or any of their variants is intended to cover a non-exclusive inclusion, so that a process, method, article, or apparatus that includes a list of elements not only includes those elements but also includes other elements that are not expressly listed, or further includes elements inherent to such a process, method, article, or apparatus. Without more limitations, an element preceded by "includes a …" does not preclude the existence of additional identical elements in the process, method, article, or apparatus that includes the element. In addition, it should be noted that, the scope of the method and apparatus in the implementations of this application is not limited to performing functions in a sequence shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

According to the foregoing descriptions of the implementations, a person skilled in the art can understand that the method in the foregoing embodiments may be implemented by software and a necessary general-purpose hardware platform, or may be implemented by hardware. However, in many cases, the former is a better implementation. Based on such an understanding, the technical solutions of this application essentially or the part contributing to the prior art may be implemented in a form of a computer software product. The computer software product is stored in a readable storage medium (for example, a ROM/RAM, a magnetic disk, or an optical disc), and includes several instructions for enabling a terminal (which may be a mobile phone, a computer, a server, a network device, or the like) to perform the methods described in the embodiments of this application.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many other manners without departing from principles of this application and the protection scope of the claims, and all such manners fall within the protection scope of this application.

1. A control method for an eye tracking apparatus, wherein the eye tracking apparatus comprises a tracking module and at least one light emitting member, the at least one light emitting member is configured to emit light to an eyeball, the tracking module is configured to: generate a first image of the eyeball, and track the eyeball based on a light spot on the eyeball in the first image, and the control method comprises:
obtaining an on/off state of the at least one light emitting member;
obtaining a light spot status corresponding to the at least one light emitting member from the first image; and
controlling, based on the on/off state and the light spot status, the at least one light emitting member to be turned on or turned off.

2. The control method according to claim 1, wherein the controlling, based on the on/off state and the light spot status, the at least one light emitting member to be turned on or turned off comprises:
when the at least one light emitting member is in an on state, and the light spot status corresponding to the at least one light emitting member is absent in N frames of consecutively generated first images, controlling the at least one light emitting member to be turned off, wherein N is a positive integer.

3. The control method according to claim 1, wherein the light spot status further comprises a quantity of pixels of the light spot, and the controlling, based on the on/off state and the at least one light spot status, the at least one light emitting member to be turned on or turned off comprises:
when the at least one light emitting member is in an on state, and the quantity of pixels of the light spot corresponding to the at least one light emitting member is greater than a first value, controlling the at least one light emitting member corresponding to the light spot to be turned off; and
when the at least one light emitting member is in the on state, and the quantity of pixels of the light spot corresponding to the at least one light emitting member is less than a second value, controlling the at least one light emitting member corresponding to the light spot to be turned off.

4. The control method according to claim 1, wherein the light spot status further comprises a ratio of a length of the light spot to a width of the light spot, and the controlling, based on the on/off state and the light spot status, the at least one light emitting member to be turned on or turned off comprises:
when the at least one light emitting member is in an on state, and the ratio of the length of the light spot corresponding to the at least one light emitting member to the width of the light spot is greater than a third value, controlling the at least one light emitting member to be turned off.

5. The control method according to claim 1, wherein the controlling, based on the on/off state and the light spot status, the at least one light emitting member to be turned on or turned off further comprises:
when duration for which the at least one light emitting member remains in an off state reaches first duration, controlling the at least one light emitting member to be turned on.

6. The control method according to claim 1, wherein the controlling, based on the on/off state and the light spot status, the at least one light emitting member to be turned on or turned off further comprises:
when a quantity of light spots in the first image is less than a fourth value, controlling all light emitting members to be turned on.

7. The control method according to claim 1, wherein before the obtaining an on/off state of the at least one light emitting member, the control method further comprises:
obtaining distribution statuses of light spots in M frames of first images, wherein M is an integer greater than or equal to 2; and
determining a correspondence between the at least one light emitting member and the light spot based on on/off states of the at least one light emitting member that correspond to the M frames of first images and the distribution statuses of the light spots in the M frames of first images, wherein the on/off states of the at least one light emitting member that correspond to the M frames of first images are different.

8. The control method according to claim 1, wherein before the obtaining an on/off state of the at least one light emitting member, the control method further comprises:
at a first moment, separately obtaining a distribution status of light spots in a first image corresponding to a left eyeball and a distribution status of the light spots in a first image corresponding to a right eyeball; and
determining a correspondence between the at least one light emitting member and the light spot based on the distribution status of the light spots in the first image corresponding to the left eyeball and the distribution status of the light spots in the first image corresponding to the right eyeball.

9. A control apparatus for an eye tracking apparatus, wherein the eye tracking apparatus comprises a tracking module and at least one light emitting member, the at least one light emitting member is configured to emit light to an eyeball, the tracking module is configured to generate a first image of the eyeball, and track the eyeball based on a light spot on the eyeball in the first image, and the control apparatus comprises:
an obtaining unit, configured to:
obtain an on/off state of the at least one light emitting member; and
obtain a light spot status corresponding to the at least one light emitting member from the first image; and
a control unit, configured to control, based on the on/off state and the light spot status, the at least one light emitting member to be turned on or turned off.

10. The control apparatus according to claim 9, wherein the control unit is configured to: when the at least one light emitting member is in an on state, and the light spot status corresponding to the at least one light emitting member is absent in N frames of consecutively generated first images, control the at least one light emitting member to be turned off, wherein N is a positive integer.

11. The control apparatus according to claim 9, wherein the light spot status further comprises a quantity of pixels of the light spot, and the control unit is configured to:
when the at least one light emitting member is in an on state, and the quantity of pixels of the light spot corresponding to the at least one light emitting member is greater than a first value, control the at least one light emitting member corresponding to the light spot to be turned off; and
when the at least one light emitting member is in the on state, and the quantity of pixels of the light spot corresponding to the at least one light emitting member is less than a second value, control the at least one light emitting member corresponding to the light spot to be turned off.

12. The control apparatus according to claim 9, wherein the light spot status further comprises a ratio of a length of the light spot to a width of the light spot, and the control unit is configured to: when the at least one light emitting member is in an on state, and the ratio of the length of the light spot corresponding to the at least one light emitting member to the width of the light spot is greater than a third value, control the at least one light emitting member to be turned off.

13. The control apparatus according to claim 9, wherein the controlling, based on the on/off state and the light spot status, the at least one light emitting member to be turned on or turned off further comprises:
when duration for which the at least one light emitting member remains in an off state reaches first duration, controlling the at least one light emitting member to be turned on.

14. The control apparatus according to claim 9, wherein the control unit is configured to: when a quantity of light spots in the first image is less than a fourth value, control all light emitting members to be turned on.

15. The control apparatus according to claim 9, wherein the obtaining unit is configured to obtain distribution statuses of light spots in M frames of first images, wherein M is an integer greater than or equal to 2; and
the control apparatus further comprises a determining unit, and the determining unit is configured to determine a correspondence between the at least one light emitting member and the light spot, based on on/off states of the at least one light emitting member that correspond to the M frames of first images and the distribution statuses of the light spots in the M frames of first images, wherein the on/off states of the at least one light emitting member that correspond to the M frames of first images are different.

16. The control apparatus according to claim 9, wherein the obtaining unit is configured to: at a first moment, separately obtain a distribution status of light spots in a first image corresponding to a left eyeball and a distribution status of the light spots in a first image corresponding to a right eyeball; and
the control apparatus further comprises a determining unit, and the determining unit is configured to determine a correspondence between the at least one light emitting member and the light spot, based on the distribution status of the light spots in the first image corresponding to the left eyeball and the distribution status of the light spots in the first image corresponding to the right eyeball.

17. An electronic device, comprising an eye tracking apparatus, a processor, and a memory, wherein the eye tracking apparatus comprises a tracking module and at least one light emitting member, the at least one light emitting member is configured to emit light to an eyeball, the tracking module is configured to: generate a first image of the eyeball, and track the eyeball based on a light spot on the eyeball in the first image; the memory stores a program, when the program is executed by the processor, cause the processor to perform operations comprising:
obtaining an on/off state of the at least one light emitting member;
obtaining a light spot status corresponding to the at least one light emitting member from the first image; and
controlling, based on the on/off state and the light spot status, the at least one light emitting member to be turned on or turned off.

18. The electronic device according to claim 17, wherein the controlling, based on the on/off state and the light spot status, the at least one light emitting member to be turned on or turned off comprises:
when the at least one light emitting member is in an on state, and the light spot status corresponding to the at least one light emitting member is absent in N frames of consecutively generated first images, controlling the at least one light emitting member to be turned off, wherein N is a positive integer.

19. The electronic device according to claim 17, wherein the light spot status further comprises a quantity of pixels of the light spot, and the controlling, based on the on/off state and the at least one light spot status, the at least one light emitting member to be turned on or turned off comprises:
when the at least one light emitting member is in an on state, and the quantity of pixels of the light spot corresponding to the at least one light emitting member is greater than a first value, controlling the at least one light emitting member corresponding to the light spot to be turned off; and
when the at least one light emitting member is in the on state, and the quantity of pixels of the light spot corresponding to the at least one light emitting member is less than a second value, controlling the at least one light emitting member corresponding to the light spot to be turned off.

20. The electronic device according to claim 17, wherein the light spot status further comprises a ratio of a length of the light spot to a width of the light spot, and the controlling, based on the on/off state and the light spot status, the at least one light emitting member to be turned on or turned off comprises:
when the at least one light emitting member is in an on state, and the ratio of the length of the light spot corresponding to the at least one light emitting member to the width of the light spot is greater than a third value, controlling the at least one light emitting member to be turned off.
